(19) United States
(12) Patent Application Publication
(10) Pub. No.: US 2014/0325440 A1
(43) Pub. Date: Oct. 30, 2014

(54) MOBILE ELECTRONIC DEVICE

(71) Applicant: KYOCERA Corporation, Kyoto-shi (JP)

(72) Inventor: Masuo KONDO, Osaka (JP)

(73) Assignee: KYOCERA Corporation, Kyoto-shi (JP)

(21) Appl. No.: 14/262,041

(22) Filed: Apr. 25, 2014

(30) Foreign Application Priority Data
Apr. 25, 2013 (JP) 2013-093060

(51) Int. Cl. G06F 3/0484; G06F 3/0481

(52) U.S. Cl. CPC G06F 3/04842; G06F 3/04817
USPC 715/814

(57) ABSTRACT

A mobile electronic device and methods are presented. A display unit displays a screen comprising objects, and an input unit covers the display unit and receives input from a user. A position judgment unit determines if an input position of the input is in a particular region in response to receiving an input from the user, and causes the objects to be displayed if the input position is in the particular region. A time judgment unit determines if a first time interval has elapsed from receiving of the input by the user in response to the position judgment unit determining that the input position is in the particular region. A display control unit displays at the input position a first object from among the objects displayed on the display unit in response to the time judgment unit determining that the first time interval has elapsed.

### CROSS-REFERENCE TO RELATED APPLICATION

The present application claims priority under 35 U.S.C. §119 to Japanese Patent Application No. 2013-093060, filed on Apr. 25, 2013, entitled “MOBILE ELECTRONIC DEVICE”. The content of which is incorporated by reference herein in its entirety.

### FIELD

Embodiments of the present disclosure relate generally to mobile electronic devices, and more particularly relate to mobile electronic devices comprising a touch panel.

### BACKGROUND

A mobile electronic device in which a display is disposed on the front surface side of an enclosure has been known. In this mobile electronic device, a substantially rectangular display that is slightly smaller than the enclosure is disposed on the substantially rectangular front surface side of the enclosure. Additionally, a touch panel is disposed so as to overlap the display, and various application programs (hereinafter referred to simply as applications) are executed based on touch operations on the display by a user.

### SUMMARY

A mobile electronic device is disclosed. The mobile electronic device comprises a display unit that displays a screen comprising a plurality of objects, a touch panel is provided to cover the display unit and that receives input from the user, a position judgment unit that determines whether or not the input position is in a particular region, when an input by a user is received when the plurality of objects are displayed determines, a time judgment unit that determines whether or not a first time has elapsed from the receiving of the input by the user, when the position judgment unit determines that the input position is in a particular region, determines, and a display control unit that displays at the input position a first object from among the plurality of objects displayed in the display unit, when the time judgment unit determines that the first time has elapsed. In this manner, embodiments of the disclosure provides a mobile electronic device which a user can operate smoothly.

In an embodiment, a mobile electronic device comprises a display unit, an input unit, a position judgment unit, a time judgment unit, and a display control unit. The display unit displays a screen comprising a plurality of objects, the input unit covers the display unit and receives input from a user. The position judgment unit determines whether or not an input position of the input is in a particular region in response to receiving an input from the user, and causes the objects to be displayed if the input position is in the particular region. The time judgment unit determines whether or not a first time interval has elapsed from receiving of the input by the user in response to the position judgment unit determining that the input position is in the particular region. The display control unit displays at the input position a first object from among the objects displayed on the display unit in response to the time judgment unit determining that the first time interval has elapsed.

In another embodiment, a method for operating a mobile electronic device displays on a display unit a screen comprising objects, covers the display unit with an input unit. The method further receives input from a user on the input unit, determines with a position judgment unit whether or not an input position of the input is in a particular region in response to receiving an input from the user. The method further displays the objects if the input position is in the particular region. The method further determines with a time judgment unit whether or not a first time interval has elapsed from receiving of the input by the user in response to the position judgment unit determining that the input position is in the particular region. The method further displays on a display control unit at the input position a first object from among the objects displayed on the display unit in response to the time judgment unit determining that the first time interval has elapsed.

In a further embodiment, a computer program product comprising a non-transitory computer readable medium comprises computer-executable instructions executable by a microprocessor for operating a mobile electronic device. The computer-executable instructions display on a display unit a screen comprising objects, cover the display unit with an input unit, and receive input from a user on the input unit. The computer-executable instructions further determine with a position judgment unit whether or not an input position of the input is in a particular region in response to receiving an input from the user. The computer-executable instructions further display the objects if the input position is in the particular region. The computer-executable instructions further determine with a time judgment unit whether or not a first time interval has elapsed from receiving of the input by the user in response to the position judgment unit determining that the input position is in the particular region. The computer-executable instructions further display on a display control unit at the input position a first object from among the objects displayed on the display unit in response to the time judgment unit determining that the first time interval has elapsed.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of an exemplary outer oblique view of a mobile electronic device according to an embodiment of the disclosure.

FIG. 2 is an illustration of an exemplary functional block diagram of a mobile electronic device according to an embodiment of the disclosure.

FIG. 3 is an illustration of an exemplary table stored in a storage unit according to an embodiment of the disclosure.

FIG. 4A and FIG. 4B are illustrations showing an exemplary particular region according to an embodiment of the disclosure.

FIG. 5 is an illustration of a flowchart showing an exemplary processing performed in the mobile electronic device according to an embodiment of the disclosure.

FIG. 6A, FIG. 6B, and FIG. 6C are illustrations showing an exemplary screen display on a display unit according to an embodiment of the disclosure.

FIG. 7A, FIG. 7B, and FIG. 7C are illustrations showing an exemplary screen display on a display unit according to an embodiment of the disclosure.

FIG. 8A, FIG. 8B, and FIG. 8C are illustrations showing an exemplary screen display on a display unit according to an embodiment of the disclosure.

FIG. 9A, FIG. 9B, and FIG. 9C are illustrations showing an exemplary screen display on a display unit according to an embodiment of the disclosure.

FIG. 10A, FIG. 10B, and FIG. 10C are illustrations showing an exemplary screen display on a display unit according to an embodiment of the disclosure.

FIG. 11A, FIG. 11B, and FIG. 11C are illustrations showing an exemplary screen display on a display unit according to an embodiment of the disclosure.

FIG. 12 is an illustration showing a user operating a mobile electronic device.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, iPod™, iPad™, display monitors, or other electronic device that uses a touch panel for displaying information.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

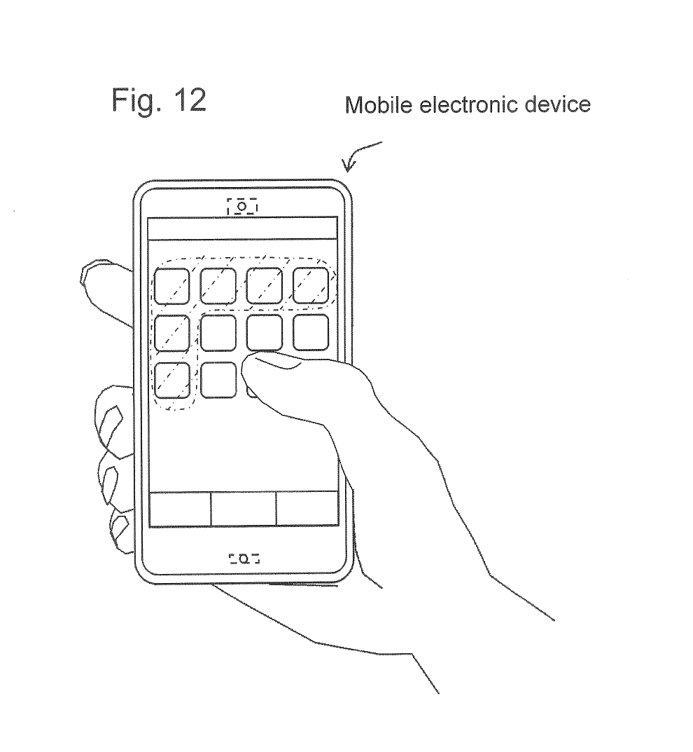

FIG. 12 shows a way that a user may be operating a mobile electronic device. There are increasing numbers of users who, as shown in FIG. 12, hold the mobile electronic device in one hand slightly toward the bottom thereof, and operate the display, meaning the touch panel disposed on the display, by his/her thumb. In recent years, a size of mobile electronic device displays has grown, and when operating is done by the thumb as noted above, it is difficult for the thumb to reach a region from a top part of the display on a side part opposite from a base of the thumb as shown by the single-dot-dashed line in FIG. 12. In order for the user to operate an operation object (such as an icon or a software key) in a region that is difficult for the thumb to reach in this manner, it is necessary to perform troublesome switching of the hands in holding the mobile electronic device.

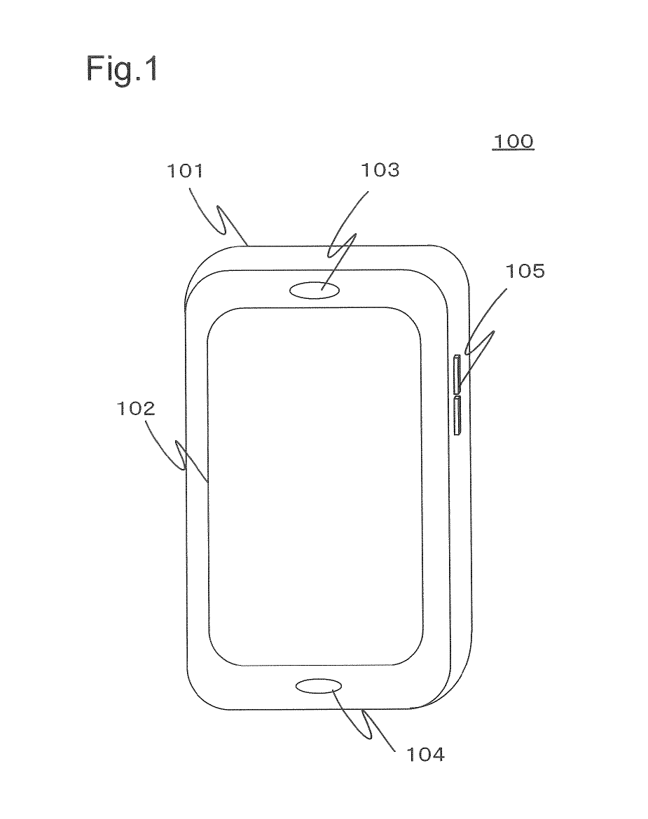

FIG. 1 is an illustration of an exemplary outer oblique view of a mobile electronic device 100 according to an embodiment of the disclosure. The mobile electronic device 100 comprises a touch panel 102, a speaker 103, a microphone 104, and an operating unit 105 are provided in an enclosure 101. The touch panel 102 displays groups of keys, such as cursor keys and numerical keys, and icons and the like, based on instructions from a user. In this document unit and module may used interchangeably.

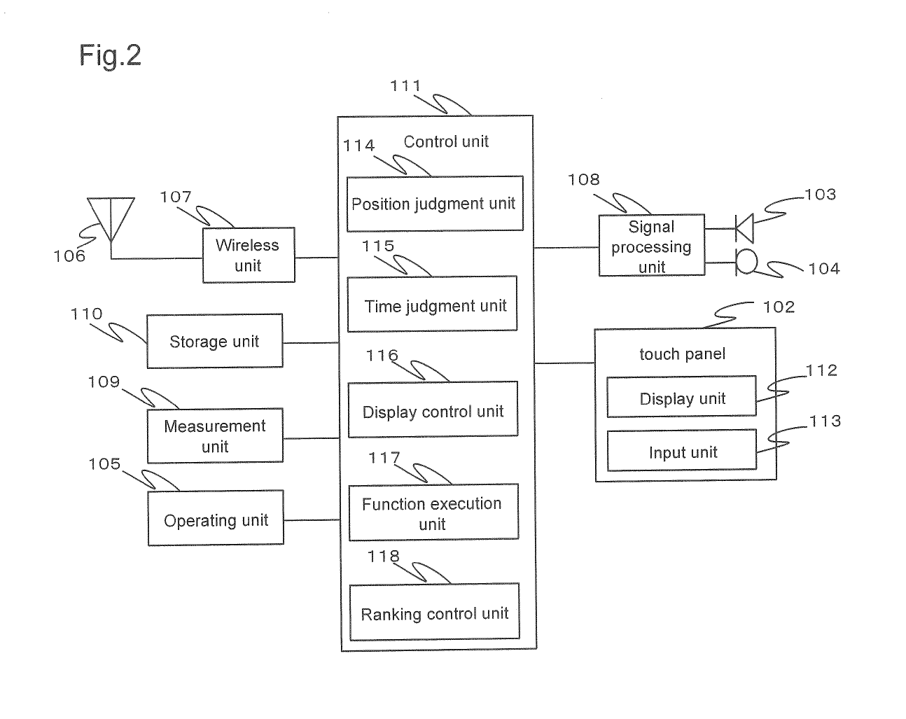

FIG. 2 is an illustration of an exemplary functional block diagram of the mobile electronic device 100 according to an embodiment of the disclosure. The mobile electronic device 100 comprises the touch panel 102, the speaker 103, the microphone 104, the operating unit 105, a wireless unit 107, a signal processing unit 108, a measurement unit 109, a storage unit 110, and a control unit 111.

The wireless unit 107 modulates and demodulates signals transmitted and received via an antenna 106. The wireless unit 107 can receive, via the antenna 106, a call request transmitted from another mobile electronic device. The wireless unit 107 can also transmit a call request to another mobile electronic device. The wireless unit 107 outputs a received call request to the control unit 111. The wireless unit 107 can receive data such as e-mail transmitted from another mobile electronic device and output it to the control unit 111.

The signal processing unit 108 performs processing for transmitting a voice signal input from the microphone 104 via the wireless unit 107, and processing for outputting to the speaker 103 a voice signal received via the wireless unit 107 from the antenna 106.

The microphone 104 outputs an input voice as a voice signal to the signal processing unit 108.

The speaker 103 outputs as a voice a voice signal processed by the signal processing unit 108 or voice data received from the control unit 111.

The measurement unit 109 can measure the time, based on an instruction from the control unit 111. The measured time is output to the control unit 111.

The operating unit 105 can accept operations by a user. The operations accepted by the operating unit 105 are output to the control unit 111. The operating unit 105 is constituted by, for example, hardware keys.

The touch panel 102 has the display unit 112 and an input unit 113.

The display unit 112 comprises an LCD (liquid crystal display) and has a function of displaying graphics such as characters and icons on the LCD, based on instructions from the control unit 111.

The input unit 113 detects touching by a user and, during the detection, outputs to the control unit 111 and the storage unit 110 the coordinate values of touch position each unit time (e.g., 1/60 second). In the present embodiment, a touch may be defined as contacting the input unit 113 by the user's finger or other touch input. A de-touch may be defined as releasing from the input unit 113 of the user's finger that had been in contact with the input unit 113. A slide may be defined as movement of the user's finger in contact with the input unit 113 while maintaining contact therewith. The input unit 113 determines a touch by the detection of coordinate values, determines a de-touch when coordinate values are no longer detected, and determines a slide when the coordinate values change with time.

Although user's finger is used as an example for generating an input on the input unit 113, other input means capable of generating an input for activating the input unit 113 upon contact may also be used. For example but without limitation, a pen may be used to make contact with the input unit 113. The input unit 113 is used in a general type of touch panel 102 that may be implemented, for example but without limitation, as a resistive film type, an optical type, or a capacitively coupled type. The input unit 113 may detect a plurality of simultaneous touches by the user. While the input unit 113 is detecting one touch by the user, it may also detect a new touch by the user. The input unit 113 may output coordinate values of a position already touched and coordinate values of the newly touched position to the control unit 111.

Although in the present embodiment the touch panel 102 is described as comprising the display unit 112 and the input unit 113, the touch panel may comprise only the input unit 113 and not comprise the display unit 112. That is, the touch panel 102 and the display unit 112 may be formed as individual devices.

The storage unit 110 is configured to store, maintain, and provide data as needed to support the functionality of the mobile electronic device 100 as processed by the control unit 111 in the manner described below. In some embodiments, the storage unit 110 may comprise, for example but without limitation, a non-volatile storage device (non-volatile semiconductor memory, hard disk device, optical disk device, and the like), a random access storage device (for example, SRAM, DRAM), or any other form of storage medium known in the art.

The storage unit 110 is configured to store each coordinate value by units of time (i.e., 1/60 second) output from the input unit 113 while a touch by the user is being detected. That is, the storage unit 110 stores coordinate values output from the time of the touch condition to the time of the de-touched condition. The storage unit 110 can also store one or more mobile telephone numbers.

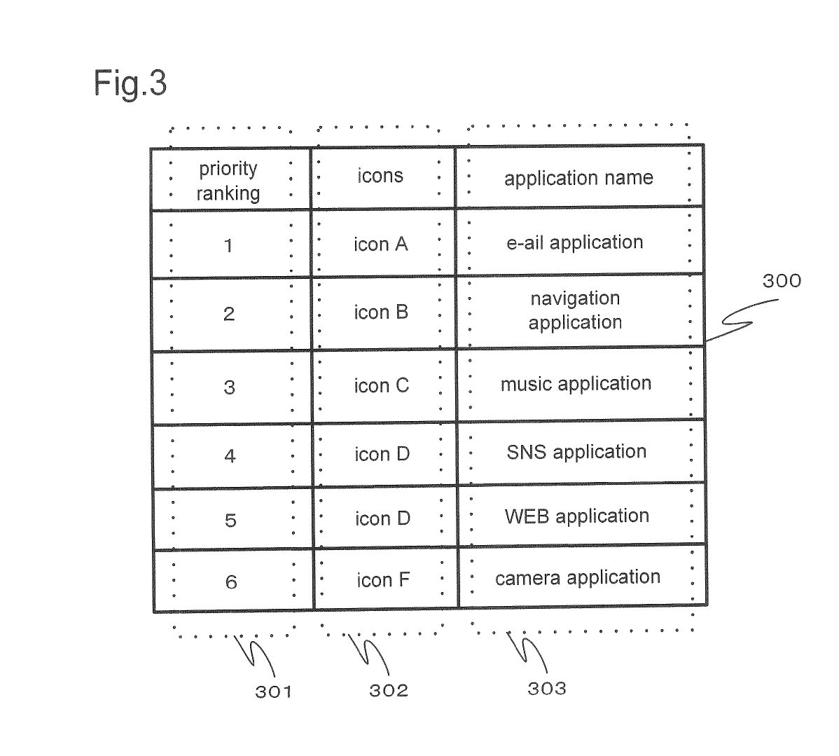

FIG. 3 is an illustration of an exemplary table 300 stored in a storage unit according to an embodiment of the disclosure. The storage unit 110, as shown in table 300 can also store an icon displayed on the display unit 112 in association with an application, and can store icons displayed on the display unit 112 with priority ranking applied thereto. Table 300 shows a relationship between priority ranking, icons, and applications. Information regarding priority ranking is stored in the column 301 surrounded by a dotted line. Information regarding icons is stored in the column 302 surrounded by a dotted line. Information regarding applications is stored in the column 303 surrounded by a dotted line. The priority ranking is higher, the lower is the number.

For example, icon A is associated with an e-mail application and is assigned 1 as the priority ranking, and icon B is associated with a navigation application and is assigned 2 as the priority ranking. In this case, the icon A is indicated as having a higher priority ranking than the icon B. The table 300 may be held for each screen displayed on the display unit 112. For example, the table 300 is related to the icons A to F displayed on the display unit 112, but it can be envisioned that a user can, for example by sliding the screen to the right, display a screen that comprises icons G to L. In this case, there can be a table similar to that of table 300, related to the icons G to L, separate from the table 300. That is, a table can be held for each screen.

The priority ranking for arranged icons can be made higher proceeding toward the top of the screen and lower proceeding toward the bottom of the screen. This enables a user to quickly select an icon in a range that would be difficult for the finger to reach accompanying making the priority ranking of icons high in a range difficult for the user's finger to reach, without troublesome operations such as switching the hand holding the mobile electronic device.

The storage unit 110 also stores the value of i, which as described below. This value of i is controlled by the control unit 111 as described below.

The control unit 111 comprises processing logic that is configured to carry out the functions, techniques, and processing tasks associated with the operation of the mobile electronic device 100. The control unit 111 comprises a position judgment unit 114, a time judgment unit 115, a display control unit 116, a function execution unit 117, and a ranking control unit 118, and can control the overall operation of the mobile electronic device 100. The control unit 111 comprises a processing means such as a central processing unit (CPU). The control unit 111 may comprises a plurality of CPUs, and executes each of the functions of the position judgment unit 114, the time judgment unit 115, the display control unit 116, the function execution unit 117, and the ranking control unit 118 by assigning them from the individual CPUs.

Alternatively, the control unit 111 may comprise only one CPU, with one CPU executing functions of the position judgment unit 114, the time judgment unit 115, the display control unit 116, function execution unit 117, and the ranking control unit 118. In either event, the control unit 111 may comprise a plurality of CPUs or a single CPU.

The control unit 111, may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

The storage unit 110 stores the functions of the position judgment unit 114, the time judgment unit 115, the display control unit 116, the function execution unit 117, and the ranking control unit 118 as a program, and the control unit 111 may obtain the program from the storage unit 110 as necessary and execute the program so as to execute the function of the position judgment unit 114 or the like. In this case, the ranking control unit 118 shown in FIG. 2 is the ranking control unit 118 after obtaining the program from the storage unit 110 and executing the program.

The position judgment unit 114 can determine whether or not the touch position of the user detected by the input unit 113 is positioned within a particular region. The position judgment unit 114 can output the result of the judgment to the time judgment unit 115. When a de-touch is detected by the input unit 113, the position judgment unit 114 can output that result to the function execution unit 117.

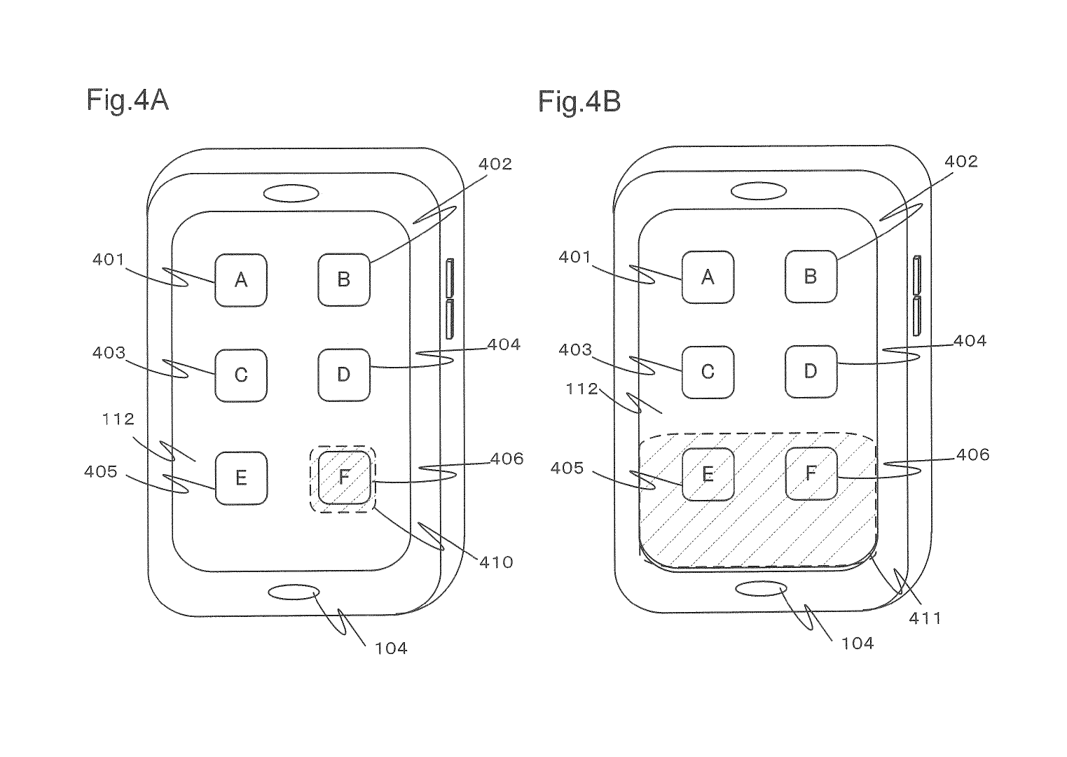

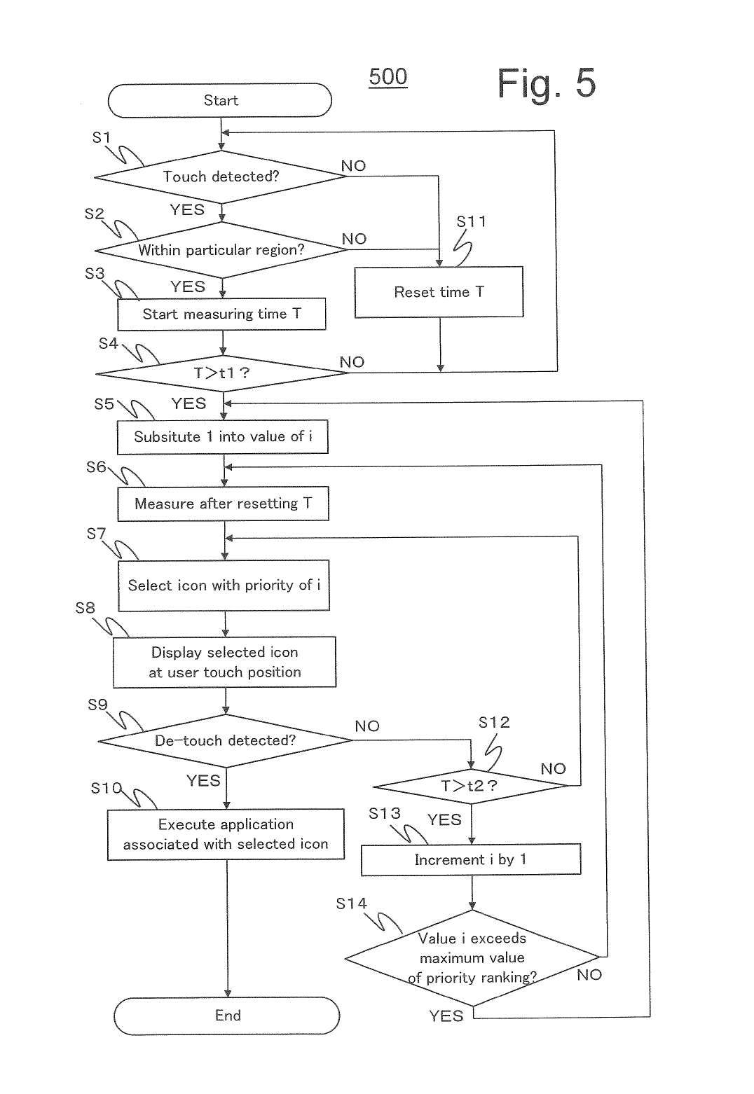

FIG. 4A and FIG. 4B are illustrations showing an exemplary particular region according to an embodiment of the disclosure. For example, as shown in FIG. 4A and FIG. 4B, the regions shaded with slanted lines may be taken as particular regions. In FIG. 4A, the region displaying an icon F406 is taken as the particular region 410. Taking the region displaying an icon F406 to be the particular region 410 enables the user to execute a process 500 shown in FIG. 5 described below, by touching a nearby icon that the finger can reach. In FIG. 4B, a part of a display region of the display unit 112 is taken to be a particular region. Specifically, of the display region of the display unit 112, a region toward the bottom is taken as the particular region 411. This enables the user to execute the process 500 of the display region of the display unit 112, by touching a region within reach of the finger. The regions shown in both FIG. 4A and FIG. 4B may be made particular regions. Although in FIG. 4A the particular region 410 was described as being the region of the icon F406, rather than taking only a region displaying the icon F406 as a particular region, a plurality of regions displaying icons may be set as a particular region. For example, regions in which the icons E405, F406, and D404 are displayed may also be taken to be a particular region.

In this manner, embodiments enable execution of the process 500 without the user performing troublesome operations, such as switching the hand holding the mobile electronic device 100, thereby enabling selection of an icon not in a range that the finger can reach. FIG. 4 shows that any arbitrary place on the display region on the display unit 112 may be set as the particular region according to the embodiments of present disclosure.

The time judgment unit 115 can instruct the measurement unit 109 to start measuring time. The time judgment unit 115 can also determine whether or not the time measured by the measurement unit 109 has reached a prescribed time. The time judgment unit 115, after instructing the measurement unit 109 to start measuring time, can instruct the measurement unit 109 to stop and cause resetting of the measured time. For example, if the time measured by the measurement unit 109 has reached a first time, the time judgment unit 115 may at that point reset the measured time and cause the measurement unit 109 to start measuring time from the start. If the time measured by the measurement unit 109 has reached the first time, the time judgment unit 115 can output that the first time has been reached to the display control unit 116 and the ranking control unit 118. If the time measured by the measurement unit 109 has reached a second time, the time judgment unit 115 can output that the second time has been reached to the display control unit 116 and the ranking control unit 118.

The display control unit 116 controls the screen displayed on the display unit 112. The display control unit 116 causes display of a plurality of icons on the display unit 112 as shown in FIG. 4 and the like. The display control unit 116 causes display of an icon at a position touched by the user, based on the output from the time judgment unit 115. Specifically, an icon having a priority ranking of the value of i can be displayed at the user touch position, based on the value of i stored in the storage unit 110. For example, if the value of i is 4, the display control unit 116 can display the icon D, the priority ranking of which is set to 4, at the user touch position.

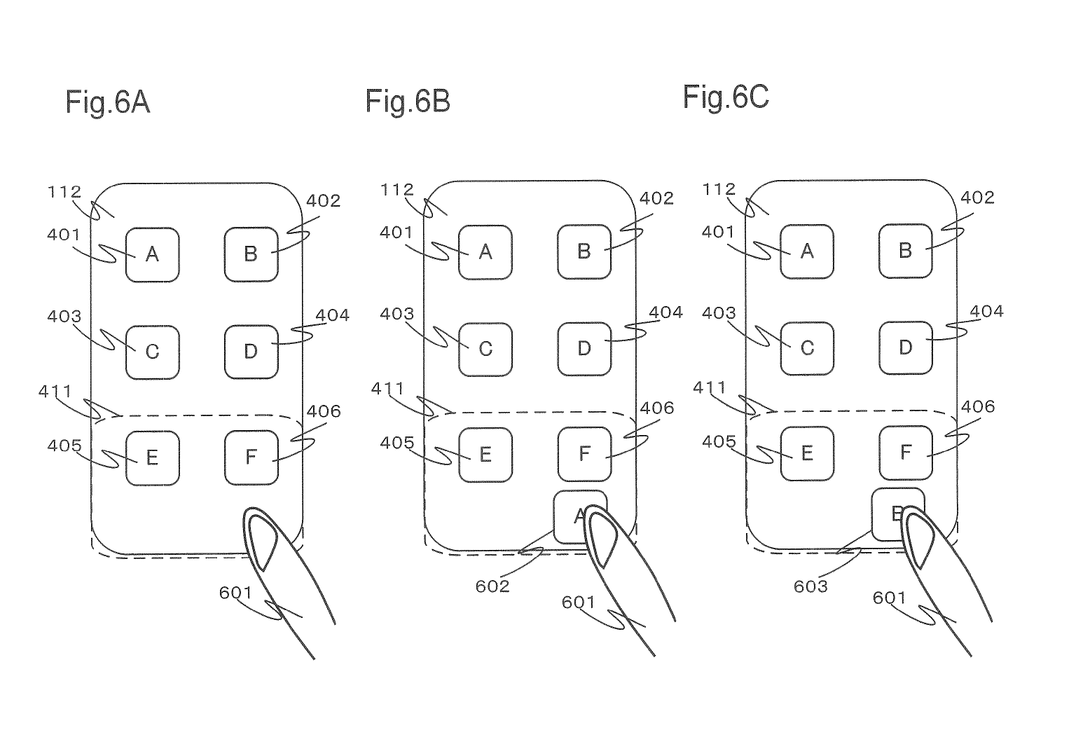

The function execution unit 117 executes an application stored in the storage unit 110. If a de-touch is detected by the input unit 113, when the touch position before the detection of the de-touch is within the display region of an icon, the application associated with that icon can be executed. For example, in FIG. 6B, if the user touch position is within the display region in which the icon A602 is displayed, and de-touch is detected by the input unit 113, the function execution unit 117 can execute the application associated with the icon A, based on the table of FIG. 3.

The ranking control unit 118 controls the value of i stored in the storage unit 110, based on the result obtained from the time judgment unit 115. Specifically, the ranking control unit 118 sets the value of i to 0 as the initial value. Then, if the time T exceeds a time t1, the ranking control unit 118 sets the value of i to 1. Next, each time the time T exceeds a time t2, the ranking control unit 118 increments the value of i by 1. After incrementing the value of i by 1, the ranking control unit 118 determine whether the value of i after incrementing by 1 has exceeded the maximum value of priority ranking indicated in FIG. 3.

Taking the example of FIG. 3, a determination is made as to whether the value of i after being incremented by 1 exceeds 6, which is the maximum value of the priority ranking. If the value of i after being incremented by 1 exceeds the maximum value of the priority ranking, the ranking control unit 118 sets the value of i to the value of the highest priority (1 in the example of FIG. 3). This enables the mobile electronic device 100 to change the icon that is caused to be displayed at the touch position based on the priority ranking each time the time t2 elapses. Although the ranking control unit 118 is described here as determining whether or not the value of i after being incremented by 1 exceeds the maximum value of the priority ranking shown in FIG. 3, this is not a restriction.

For example, after incrementing the value of i by 1, the ranking control unit 118 may determine whether the value of i after incrementing by 1 has exceeded the number of icons displayed on the display unit 112. For example, in FIG. 6 there are six icons displayed on the display unit 112, and the ranking control unit 118 may determine whether the value of i has exceeded 6.

FIG. 5 is an illustration of an exemplary flowchart showing an operation of the mobile electronic device 100 (process 500) according to an embodiment of the disclosure. The various tasks performed in connection with the process 500 may be performed by software, hardware, firmware, a computer-readable medium having computer executable instructions for performing the process method, or any combination thereof. The process 500 may be recorded in a computer-readable medium such as a semiconductor memory, a magnetic disk, an optical disk, and the like, and can be accessed and executed, for example, by a computer CPU in which the computer-readable medium is stored.

It should be appreciated that process 500 may comprise any number of additional or alternative tasks, the tasks shown in FIG. 5 need not be performed in the illustrated order, and process 500 may be incorporated into a more comprehensive procedure or process having additional functionality not described in detail herein. In some embodiments, portions of the process 500 may be performed by different elements of the mobile electronic device 100 explained above. Process 500 may have functions, material, and structures that are similar to the embodiments shown in FIGS. 1-4. Therefore common features, functions, and elements may not be redundantly described here. In process 500, the display unit 112 displays icons such as shown in FIG. 6A, and a particular region is taken as the particular region 411 surrounded by a dotted line.

The input unit 113 detects whether or not there is a touch by the user with respect to the display unit 112 (S1). If the input unit 113 detects a user touch (YES at S1), it outputs that result to the position judgment unit 114.

The position judgment unit 114 determine whether or not the position touched by the user and detected by the input unit 113 (sometimes referred to as the user touch position) is included within the particular region 411 (S2). If, for example as shown in FIG. 6A, the position touched by the user's finger 601 is within the particular region (YES at S2), that result is output to the time judgment unit 115.

If the position judgment unit 114 determines that the user touch position is within the particular region, the time judgment unit 115 causes the measurement unit 109 to start measuring time (S3). The time judgment unit 115 determines whether or not the time T measured by the measurement unit 109 has exceeded the first time t1 (S4). If the time T has not exceeded t1 (NO at S4), return is made to the first processing S1.

After the time judgment unit 115 causes the measurement unit 109 to start measuring time, if the position judgment unit 114 determines that the touch position is not within the particular region 411 (NO at S2), the time judgment unit 115 stops the measurement of time by the measurement unit 109 and resets the value of the time T (S11). The touch position not being within the particular region 411 can be, for example, a case in which, when the input unit 113 detects a de-touch or the user touch position slides, the user touch position has moved to outside the particular region 411.

If the time judgment unit 115 determines that the time T measured by the measurement unit 109 has exceeded the first time t1 (YES at S4), it outputs that result to the display control unit 116 and the ranking control unit 118.

If the time T measured by the measurement unit has exceeded the time t1, the ranking control unit 118 substitutes 1 into the value of i stored in the storage unit (S5). The time judgment unit 115 resets the time T measured by the measurement unit 109 and causes the measurement unit 109 to execute measurement of the time T anew (S6).

The display control unit 116 obtains the value of i stored in the storage unit 110 and references the table stored in the storage unit 110 to select an icon having a priority ranking of the value of i (S7). After selecting the icon, the display control unit 116 displays the selected icon at the user touch position (S8). For example, as shown in FIG. 6B, if the value of i passes through S5, because the value of i is 1, the icon A602 is displayed at the touch position. If the value of i is set to 1 and this passes through S13, to be described below, the value of i is incremented by 1 and becomes 2. As a result, as shown in FIG. 6B, the display control unit 116 displays the icon B603 at the user touch position. Because incrementing by 1 is done each time of passing through S13, the icon sequence of icon A, icon B, icon C, icon D, icon E, icon F, and then icon A again will be displayed at the touch position.

After an icon is displayed at the touch position, a determination is made by the input unit 113 as to whether or not de-touch is detected (S9). If the input unit 113 determines that de-touch has been detected (YES at S9), the function execution unit 117 executes the application associated with the icon displayed at the touch position (S10). For example, in FIG. 6B, in the case in which the icon A602 is displayed at the touch position, when the input unit 113 detects a de-touch (that is, that the user's finger 601 has moved away from the touch panel), the function execution unit 117 executes the e-mail application corresponding to the icon A602. In FIG. 6C, the function execution unit 117 executes the navigation application corresponding to the icon B603.

If a de-touch is not detected by the input unit 113, the time judgment unit 115 determines whether or not the time T has exceeded the second time t2 (S12). If the time T does not exceed the time t2, return is made to the processing of S7.

If the time T exceeds the second time t2, the ranking control unit 118 increments the value of i by 1 (S13). After incrementing the value of i by 1, the ranking control unit 118 determines whether the value of i after the incrementing exceeds the maximum value of priority ranking (S14). If the value of i exceeds the maximum value of priority ranking (YES at S14), transition is made to S7, and the ranking control unit 118 substitutes 1 into the value of i (S7). If the ranking control unit 118 determines that the value of i after incrementing does not exceed the maximum value of priority ranking (NO at S14), transition is made to S6. At S6, the time judgment unit 115 resets the measurement by the measurement unit 109 so as to make an initial value setting and causes the measurement unit to start measurement (S6).

By the above-noted processing, when a prescribed time has elapsed with the user touch position being within the particular region 411, the mobile electronic device 100 can sequentially display icons displayed on the display unit 112 at the touch position, based on the priority ranking. Doing this enables selection of one icon displayed on the display unit 112, without performing troublesome operations such as switching of the hands in holding the mobile electronic device.

### Further Embodiments

As shown in FIG. 6, although it has been described in the present embodiment that an icon is displayed at the position touched by a user, and the displayed icon is to be changed with elapsed of time, this is not a limitation. For example, as shown in FIG. 4A, in the case in which a particular region is set in the region displaying an icon, when the icon in a region set as a particular region is touched, the icon displayed at the touch position may be changed in accordance with the priority ranking.

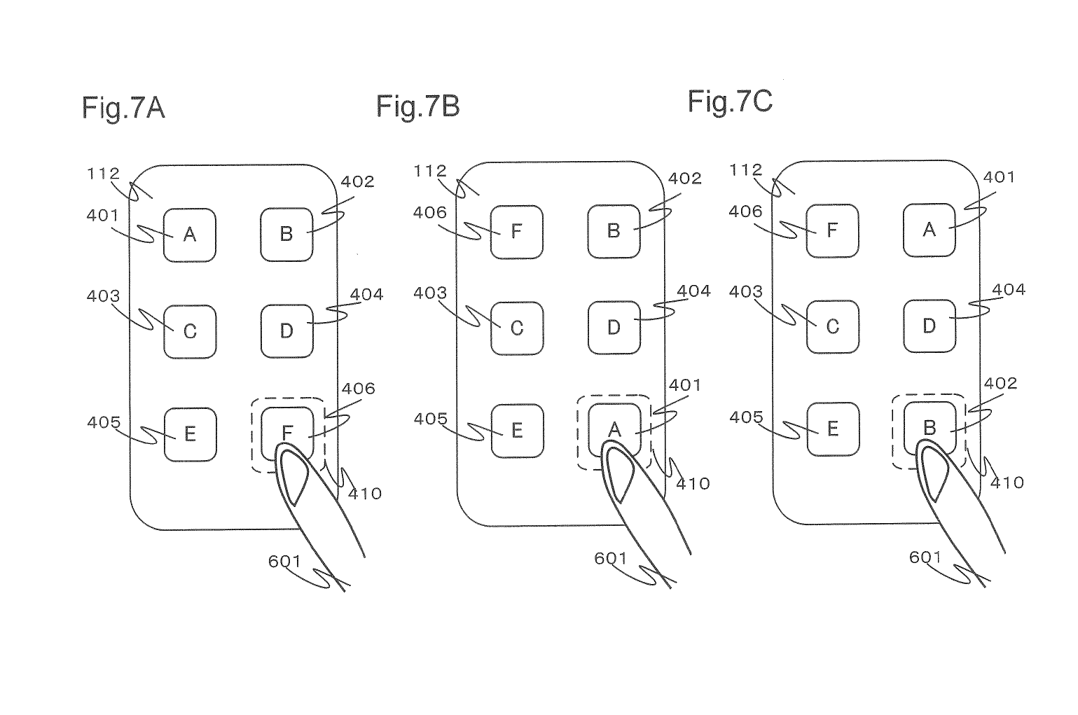

The above operation will be described using FIG. 7 to FIG. 9. FIG. 7 to FIG. 9 illustrate a mode of switching the display of an icon disposed (located) at the position in which the touch position is detected, when the particular region is set in the icon display region.

In FIG. 7, the particular region 410 is set as the region in which the icon F406 is displayed. In FIG. 7A, when a user touches the icon F406 if the time T exceeds a time t1, the icon A401 having the priority ranking “1” may be exchanged with the icon F406, as shown in FIG. 7B. Next, when the icon A401 having the priority ranking 1 is displayed, if the time T exceeds a time t2, as shown in FIG. 7C, the icon B402 having the priority ranking 2 may be exchanged with the icon A401.

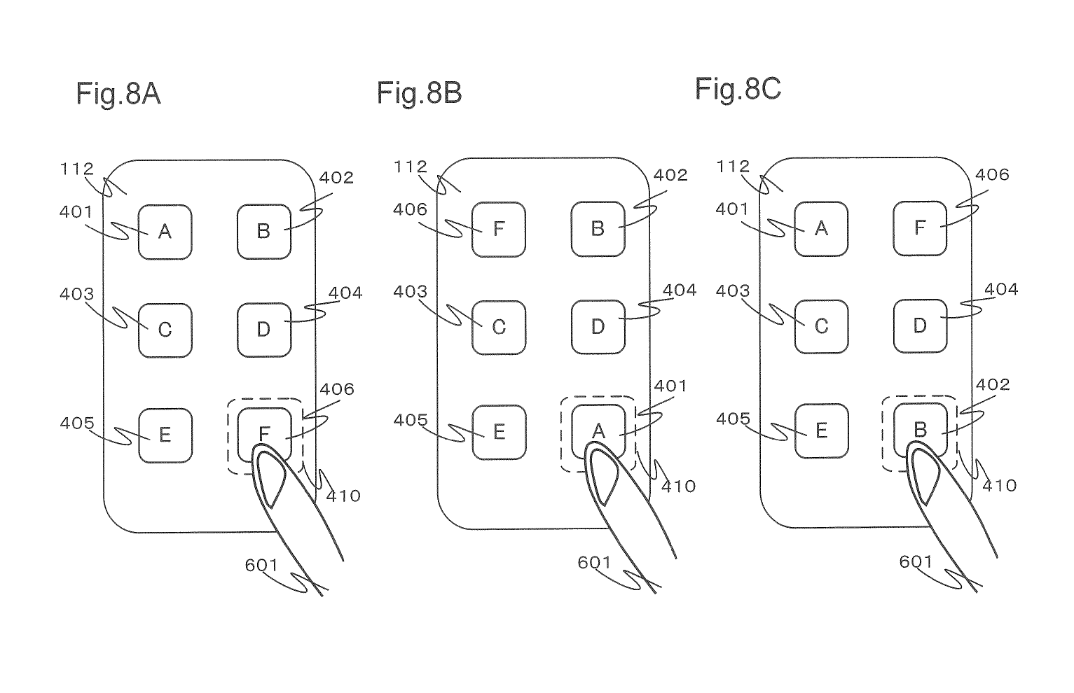

In FIG. 8, the particular region 410 has been set as the region in which the icon F406 is displayed. In FIG. 8A, when a user touches the icon F406 if the time T exceeds the time t1, the icon A401 having the priority ranking 1 may be exchanged with the icon F406 as shown in FIG. 8B. Next, when the icon A401 having the priority ranking 1 is displayed, if the time T exceeds a time t2, as shown in FIG. 8C, the icon A401 displayed in FIG. 8B is returned to the position of the icon A401 displayed in FIG. 8A, and the arrangement of the icon B402 and the icon F406 may be exchanged.

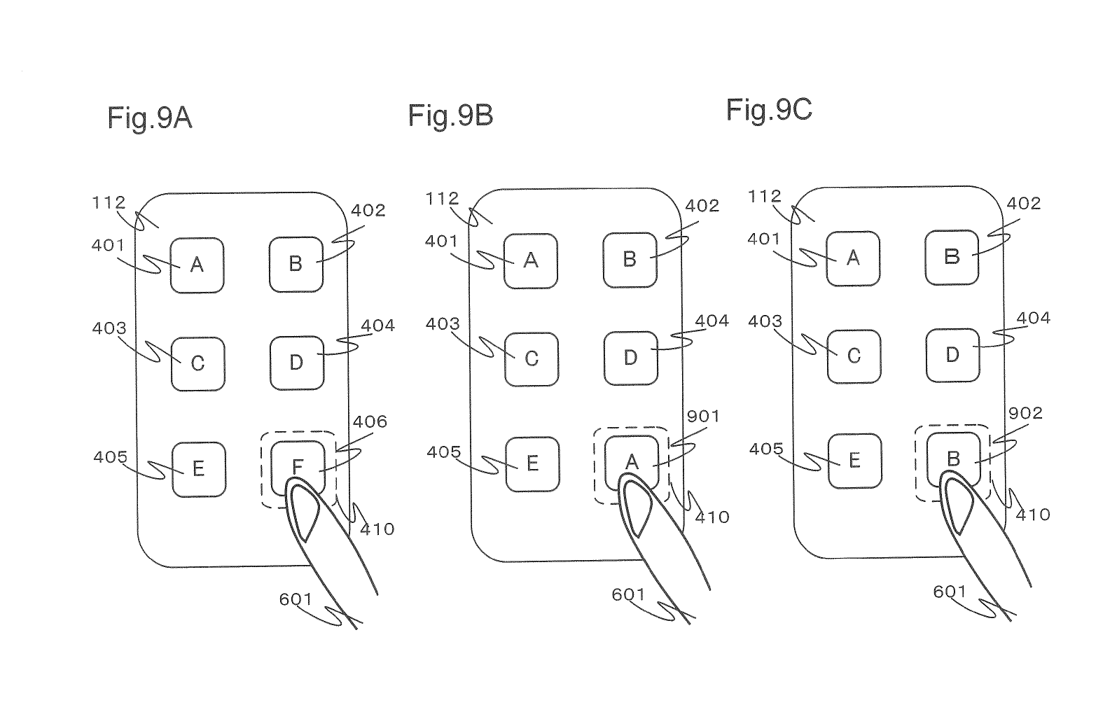

In FIG. 9, the particular region 410 has been set as the region in which the icon F406 is displayed. In FIG. 9A, when a user touches the icon F406 if the time T exceeds the time t1, the icon A901 as the same graphic as the icon A401 having the priority ranking 1 may be exchanged with the icon F406, as shown in FIG. 9B. Next, when the icon A901 having the priority ranking 1 is displayed, if the time T exceeds the second time t2, the icon B902 may be displayed in place of the icon A901 displayed in FIG. 9B, as shown in FIG. 9C. In the case of FIG. 9, if the value of i becomes equal to the priority ranking of the icon F406, the icon F406 will be displayed at the touch position.

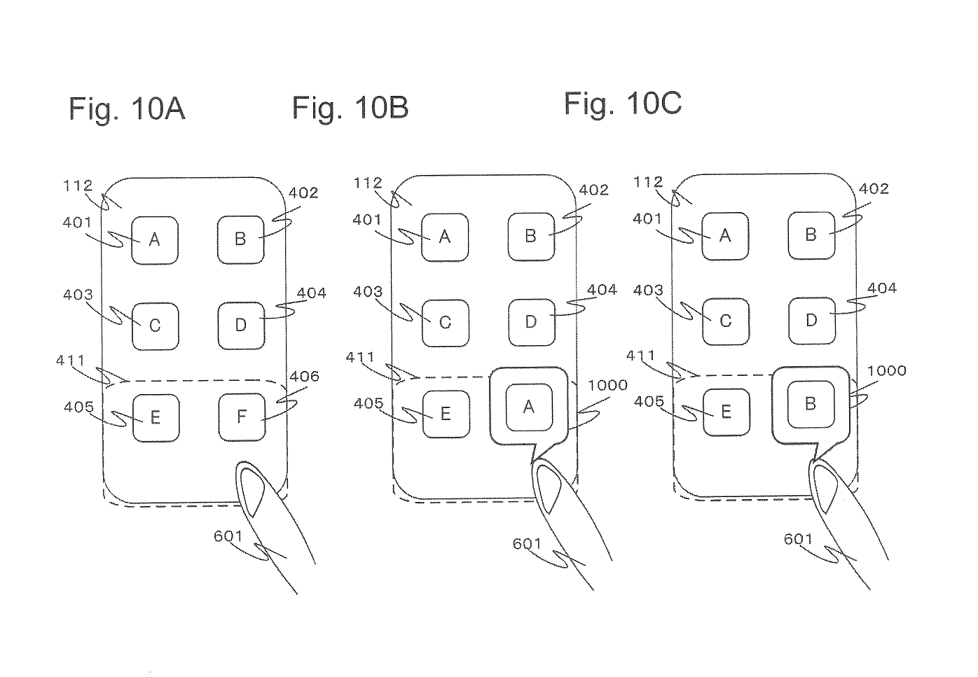

Although FIG. 6 shows icons displayed at the touch position, it is not necessary for the icons to be displayed at the touch position. For example, in FIG. 10, when the touch by a user is detected within a particular region and the first time has elapsed, a pop-up 1000 may be displayed and the icon A may be displayed therewithin, as shown in FIG. 10B. Also, when the second time has elapsed from the time of FIG. 10B, the icon displayed in the pop-up 1000 may be changed. For example, when the second time elapsed, the icon B may be displayed within the pop-up 1000, as shown in FIG. 10C. The graphics of icons are displayed some distance from the touch position using the pop-up or the like, thereby enabling avoidance of the icon graphic being hidden by the user's figure, and enabling the user to know rapidly what icon is displayed at the touch position. In FIG. 10, although the pop-up is displayed so as to overlap the icon F406, icons may be displayed so as not to overlap any of the icons A401 to A406.

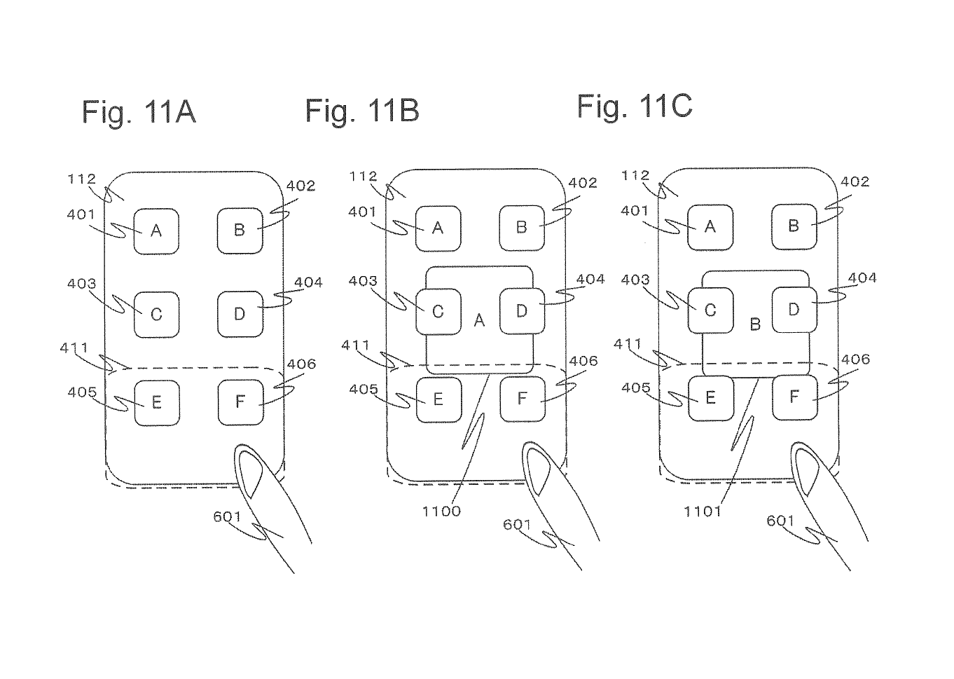

As shown in FIG. 11, when the touch by a user is detected within a particular region and the first time has elapsed, the icon A1100 may be displayed as a background graphic displayed in the display unit 112, as shown in FIG. 11B. Also, when the second time has elapsed from the time of FIG. 11B, the icon B1101 may be displayed as the background graphic displayed on the display unit 112, as shown in FIG. 11C. Such display of icons as background graphics enables avoidance of the icon graphic being hidden by the user's finger, and enables the user to know rapidly what icon is displayed at the touch position.

According to the embodiments, when the user touch position exists within the particular region 411 and a prescribed time has elapsed, the mobile electronic device 100 can display the icons displayed in the display unit 112 sequentially at the touch position, based on the priority ranking. This enables user to select one of the icons displayed in the display unit 112, without performing troublesome switching of the hands in holding the mobile electronic device.

In this document, the terms “computer program product”, “computer-readable medium”, and the like may be used generally to refer to media such as, for example, memory, storage devices, storage unit, or other non-transitory media. These and other forms of computer-readable media may be involved in storing one or more instructions for use by the control unit 111 to cause the control unit 111 to perform specified operations. Such instructions, generally referred to as “computer program code” or “program code” (which may be grouped in the form of computer programs or other groupings), when executed, enable a method of using a system such as the mobile electronic device 100.

While at least one example embodiment has been presented in the foregoing detailed description, it should be appreciated that a vast number of variations exist. It should also be appreciated that the example embodiment or embodiments described herein are not intended to limit the scope, applicability, or configuration of the subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

The above description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although above Figures depict example arrangements of elements, additional intervening elements, devices, features, or components may be present in an embodiment of the disclosure.

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a display unit configured to display a screen comprising a plurality of objects;
an input unit configured to cover the display unit and receive input from a user;
a position judgment unit configured to determine whether or not an input position of the input is in a particular region in response to receiving an input from the user, and causes the objects to be displayed if the input position is in the particular region;
a time judgment unit configured to determine whether or not a first time interval has elapsed from receiving of the input by the user in response to the position judgment unit determining that the input position is in the particular region; and
a display control unit configured to display at the input position a first object from among the objects displayed on the display unit in response to the time judgment unit determining that the first time interval has elapsed.

2. The mobile electronic device of claim 1, wherein:
the time judgment unit is further configured to determine whether or not a second time interval has elapsed from the display of the objects, in response to the objects being displayed at the input position; and
the display control unit is further configured to display, at the input position, a second object different from the first object from among the plurality of objects displayed on the display unit in response to the time judgment unit determining that the second time has elapsed.

3. The mobile electronic device of claim 2, further comprising:
a storage unit configured to store a priority ranking of the objects, wherein the display control unit is configured to:
display an object having a highest priority ranking in response to the first time being elapsed; and
display at the input position an object having next highest priority ranking of priority rankings established for the objects displayed at the input position in response to the second time being elapsed.

4. The mobile electronic device of claim 3, wherein the storage unit is further configured to store a relationship between the priority ranking, icons, and applications.

5. The mobile electronic device of claim 3, wherein the priority ranking is made higher proceeding toward a top of the screen and lower proceeding toward a bottom of the screen.

6. The mobile electronic device of claim 1, wherein the particular region comprises a region in which at least one object is displayed from among the objects.

7. A method for operating a mobile electronic device comprising:
displaying on a display unit a screen comprising a plurality of objects;
covering the display unit with an input unit;
receiving input from a user on the input unit;
determining with a position judgment unit whether or not an input position of the input is in a particular region in response to receiving an input from the user;
displaying the objects if the input position is in the particular region;
determining with a time judgment unit whether or not a first time interval has elapsed from receiving of the input by the user in response to the position judgment unit determining that the input position is in the particular region; and
displaying on a display control unit at the input position a first object from among the objects displayed on the display unit in response to the time judgment unit determining that the first time interval has elapsed.

8. The method of claim 7, further comprising:
determining by action of the time judgment unit whether or not a second time interval has elapsed from the display of the objects, in response to the objects being displayed at the input position; and
displaying by action of the display control unit, at the input position, a second object different from the first object from among the plurality of objects displayed on the display unit in response to the time judgment unit determining that the second time has elapsed.

9. The method of claim 8, further comprising:
displaying by action of the display control unit an object having a highest priority ranking in response to the first time being elapsed, wherein a storage unit is configured to store a priority ranking of the objects; and
displaying at the input position an object having next highest priority ranking of priority rankings established for the objects displayed at the input position in response to the second time being elapsed.

10. The method of claim 9, further comprising storing a relationship between the priority ranking, icons, and applications.

11. The method of claim 9, wherein the priority ranking is made higher proceeding toward a top of the screen and lower proceeding toward a bottom of the screen.

12. The method of claim 7, wherein the particular region comprises a region in which at least one object is displayed from among the objects.

13. A computer program product comprising a non-transitory computer readable medium comprising computer-executable instructions executable by a microprocessor for operating a mobile electronic device, the computer-executable instructions comprising:
displaying on a display unit a screen comprising a plurality of objects;
covering the display unit with an input unit;
receiving input from a user on the input unit;
determining with a position judgment unit whether or not an input position of the input is in a particular region in response to receiving an input from the user;
displaying the objects if the input position is in the particular region;
determining with a time judgment unit whether or not a first time interval has elapsed from receiving of the input by the user in response to the position judgment unit determining that the input position is in the particular region; and
displaying on a display control unit at the input position a first object from among the objects displayed on the display unit in response to the time judgment unit determining that the first time interval has elapsed.

14. The computer program product comprising the non-transitory computer readable medium of claim 13, the computer-executable instructions further comprising:
determining with the time judgment unit whether or not a second time interval has elapsed from the display of the objects, in response to the objects being displayed at the input position; and
displaying with the display control unit, at the input position, a second object different from the first object from among the plurality of objects displayed on the display unit in response to the time judgment unit determining that the second time has elapsed.

15. The computer program product comprising the non-transitory computer readable medium of claim 14, further comprising:
displaying with the display control unit an object having a highest priority ranking in response to the first time being elapsed, wherein a storage unit configured to store a priority ranking of the objects; and
displaying at the input position an object having next highest priority ranking of priority rankings established for the objects displayed at the input position in response to the second time being elapsed.

16. The computer program product comprising the non-transitory computer readable medium of claim 15, further comprising storing a relationship between the priority ranking, icons, and applications.

17. The computer program product comprising the non-transitory computer readable medium of claim 15, wherein the priority ranking is made higher proceeding toward a top of the screen and lower proceeding toward a bottom of the screen.

18. The computer program product comprising the non-transitory computer readable medium of claim 13, wherein the particular region comprises a region in which at least one object is displayed from among the objects.

19. The computer program product comprising the non-transitory computer readable medium of claim 13, wherein the particular region comprises a plurality of regions displaying icons.

20. The computer program product comprising the non-transitory computer readable medium of claim 13, further enabling selection of an icon in the particular region that is not otherwise reachable by a user.
